(19) United States
(12) Patent Application Publication
(10) Pub. No.: US 2025/0046908 A1
(43) Pub. Date: Feb. 6, 2025

(54) BATTERY CELL ASSEMBLY, BATTERY PACK AND VEHICLE WITH THE BATTERY PACK

(71) Applicant: FORD GLOBAL TECHNOLOGIES, LLC, Dearborn, MI (US)

(72) Inventors: Larry WANG, Nanjing (CN); Fei GAO, Hefei (CN)

(21) Appl. No.: 18/785,524

(22) Filed: Jul. 26, 2024

(30) Foreign Application Priority Data
Jul. 31, 2023 (CN) 202322044037.1

(51) Int. Cl. H01M 10/6557; H01M 10/613; H01M 10/658; H01M 50/249; H01M 50/264

(52) U.S. Cl. CPC H01M 10/6557; H01M 10/613; H01M 10/658; H01M 50/264; H01M 50/249

(57) ABSTRACT

A battery cell assembly, a battery pack, and a vehicle with the battery pack are provided herein. The battery cell assembly includes a battery cell and a pair of side plates located on opposite sides of the battery cell. At least one of the side plates is provided with a connecting structure configured to connect an adjacent battery cell assembly. The battery cell assembly further includes a cooling component integrated at least partially into the side plate for cooling the battery cell. Integrating a portion of the cooling component and the connecting structure into the side plate eliminates the need for additional cooling plates, which not only increases efficiency and facilitates the assembly of multiple battery cell assemblies, but also increases space utilization, thereby increasing energy density of the battery.

### CROSS-REFERENCE TO RELATED APPLICATIONS

This disclosure claims priority to Chinese Patent Application No. 202322044037.1, which was filed on Jul. 31, 2023 and is incorporated herein by reference in its entirety.

### TECHNICAL FIELD

The embodiments of this disclosure relate to the field of batteries, particularly to a battery cell assembly, a battery pack, and a vehicle with the battery pack.

### BACKGROUND

The existing technology CN218069963U discloses a battery cell cooling structure including a frame having side plates on both sides and end plates at both ends. Wherein, a battery cell mounting space is defined in the frame, and a cooling channel for cooling liquid to circulate is formed in the frame. The cooling channel is configured to enable the cooling liquid to flow in from one of the end plates and flows through each side plate before flowing out through the other end plate.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

One purpose of the present disclosure is to provide a battery cell assembly, a battery pack, and a vehicle with the battery pack.

To achieve the above objectives, one aspect of the embodiments of the present disclosure relates to a battery cell assembly. The battery cell assembly includes a battery cell and a pair of side plates located on opposite sides of the battery cell. At least one of the side plates is provided with a connecting structure configured to connect an adjacent battery cell assembly. The battery cell assembly further includes a cooling component for cooling the battery cell. The cooling component is at least partially integrated into the side plate.

According to an embodiment of the present disclosure, the cooling component includes cooling channels extending along a length direction of the side plate and running through the side plate, and the cooling channels are configured to allow cooling medium to flow through to cool the battery cell, and the cooling channels are integrated into the side plate.

According to an embodiment of the present disclosure, the cooling channel is closer to the battery cell relative to the connecting structure, the cooling channel is located on the side of the side plate near the battery cell, and the connecting structure is located on the side of the side plate away from the battery cell.

According to an embodiment of the present disclosure, the cooling component includes cooling channels extending along a length direction of the side plate and running through the side plate, the connecting structure is located on an outer side of the side plate, and the cooling channels are integrated with the connecting structure.

According to an embodiment of the present disclosure, the connecting structure includes multiple convex locking pieces and concave locking pieces that are alternately arranged and matched with each other, the convex locking piece has a through hollow structure, and the cooling channel is formed by the hollow structure.

According to an embodiment of the present disclosure, the connecting structure includes multiple convex locking pieces and concave locking pieces that are alternately arranged and matched with each other, and the connecting structure is configured so that when adjacent battery cell assemblies are connected, the convex locking pieces slide into the corresponding concave locking pieces to interlock the corresponding battery cell assemblies.

According to an embodiment of the present disclosure, the convex locking pieces and the concave locking pieces are in an interference fit at the middle and/or rear end of the concave locking pieces along a direction in which the convex locking pieces slide inside the concave locking pieces.

According to an embodiment of the present disclosure, the battery cell assembly includes a pair of first and second end plates located at both ends of the battery cell and connected to the side plates, the cooling component further includes a cooling inlet and a cooling outlet in fluid communication with the cooling channels, the cooling inlet is located on the first end plate, and the cooling outlet is located on the second end plate; the first end plate also has a first cooling medium delivery pipeline connecting the cooling inlet and the cooling channels, and the second end plate also has a second cooling medium delivery pipeline connecting the cooling channels and the cooling outlet. The cooling medium flows through the cooling inlet and the first cooling medium delivery pipelines, enters the cooling channels, then flows through the second cooling medium delivery pipelines and flows out through the cooling outlet.

According to an embodiment of the present disclosure, the connecting structure includes a mortise and tenon connecting structure, through which adjacent battery cell assemblies are detachably connected to each other.

Another aspect of this disclosure relates to a battery pack, including: a shell formed with an accommodating chamber in the interior; and multiple battery cell assemblies as described above, wherein the battery cell assemblies include a first battery cell assembly and a second battery cell assembly; and the first battery cell assembly and the second battery cell assembly are connected to each other through the connecting structures.

According to an embodiment of the present disclosure, the connecting structures include a first connecting structure, the first connecting structure includes multiple convex locking pieces and concave locking pieces that are alternately arranged and matched with each other, and the convex locking pieces of the first battery cell assembly slide into the concave locking pieces of the second battery cell assembly to connect the first battery cell assembly and the second battery cell assembly in an interlocking manner.

According to an embodiment of the present disclosure, the connecting structures further include a second connecting structure, the second connecting structure includes aerogel coated on the side plate to connect the first battery cell assembly and the second battery cell assembly; and the first connecting structure and the second connecting structure are alternately arranged between the battery cells.

Yet another aspect of this disclosure relates to a vehicle with a battery pack, including the battery pack as described above.

### BRIEF DESCRIPTION OF THE FIGURES

For a better understanding of this disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like reference numbers refer to like parts throughout the different figures.

FIG. 1 is an exploded view of a battery cell assembly according to an embodiment of the present disclosure;

FIG. 2 is a partial perspective view of a battery cell assembly according to an embodiment of the present disclosure;

FIG. 3 is a partial assembled view of two battery cell assemblies shown in FIG. 2;

FIG. 4 is a partial perspective view of a battery cell assembly according to another embodiment of the present disclosure;

FIG. 5 is a partial assembled view of three battery cell assemblies shown in FIG. 4;

FIG. 6 is a partial perspective view of a battery cell assembly according to yet another embodiment of the present disclosure;

FIG. 7 is a partial perspective view of a battery cell assembly according to yet another embodiment of the present disclosure; and

FIG. 8 is a partial perspective view of a battery pack according to an embodiment of the present disclosure.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

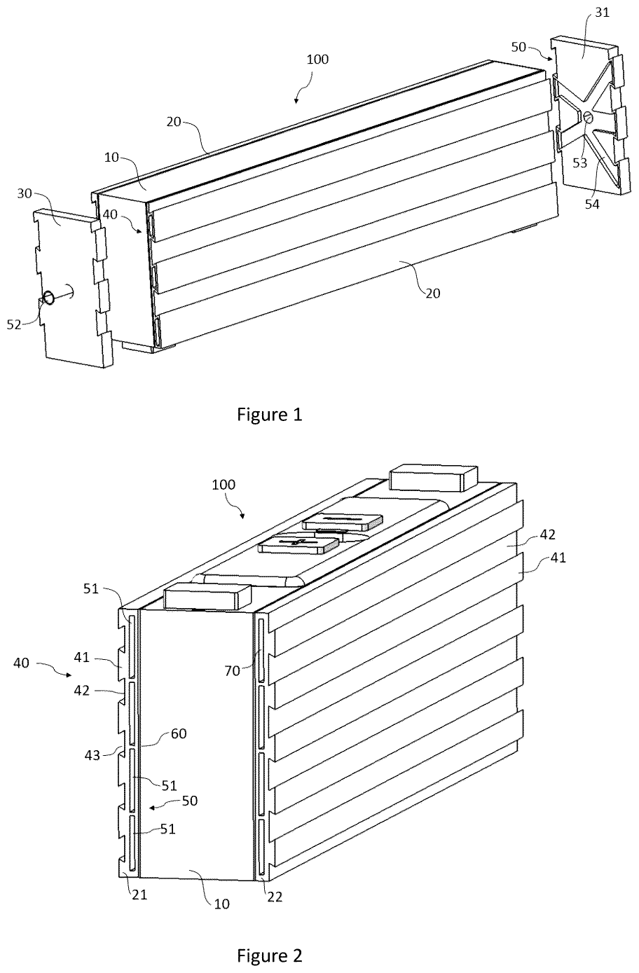

FIG. 1 shows a partial exploded view of a battery cell assembly 100. The battery cell assembly 100 includes a battery cell 10 and a pair of side plates 20 located on opposite sides of the battery cell 10. The battery cell assembly 100 further includes a pair of end plates (specifically a first end plate 30 and a second end plate 31) located at both ends of the battery cell 10 and connected to the side plates 20, and a bottom plate located at the bottom of the battery cell 10 and connected to the side plates 20 and the end plates. The first end plate 30, the second end plate 31, the bottom plate, and the side plates 20 respectively cover the surface of the battery cell 10.

In an embodiment, the first end plate 30, the second end plate 31, and the side plates 20 are made of metal.

The side plates 20 include a first side plate 21 and a second side plate 22 located on both sides of the battery cell 10. At least one of the side plates 20 is provided with a connecting structure 40 configured to connect an adjacent battery cell assembly 100.

In an embodiment, both the first side plate 21 and the second side plate 22 are provided with the connecting structure 40, and adjacent battery cell assemblies 100 are connected to each other through the connecting structures 40 located on both sides. In another embodiment, one of the side plates 20 is provided with the connecting structure 40, one side of the adjacent battery cell assemblies 100 is connected with each other through the connecting structures 40 integrated into the side plate 20, and the other side of the battery cell assemblies 100 is connected with each other through an auxiliary connecting structure such as heat conduction glue or aerogel.

The battery cell assembly 100 further includes a cooling component 50 for cooling the battery cell 10. The cooling component 50 is at least partially integrated into the side plate 20. Due to the relatively large surface area of the side plate 20, integrating the cooling component 50 into the side plate 20 will increase the cooling surface compared to integrating it into the end plate or the bottom plate, which can augment cooling effect and battery security. In an embodiment, both side plates 20 are integrated with the cooling component 50; and in another embodiment, one of the side plates 20 is integrated with the cooling component 50.

In this implementation, the connecting structure 40 for connecting the adjacent battery cell assembly 100 and a portion of the cooling component 50 are integrated into the side plate 20. Therefore, there is no need to install additional cooling plates, which reduces the number of components, increases efficiency of the battery cell assemblies, and facilitates the assembly of multiple battery cell assemblies, and also increases space utilization, thereby increasing energy density of the battery.

The cooling component 50 includes multiple cooling channels 51 extending along a length direction of the side plate 20 and running through the side plate 20. The cooling channels 51 are configured to allow cooling medium to flow through to cool the battery cell 10, and the cooling channels 51 are integrated into the side plate 20. The cooling channels 51 extend along a front edge of the side plate 20 to a rear edge of the side plate 20, increasing the area of the cooling medium flowing through the battery cell 10 and further improving the cooling effect.

A thermal conductive layer 60 is provided between the battery cell 10 and the cooling channels 51 to fully exchange the heat of the battery cell 10 with the cooling medium, thus improving the heat exchange performance of the battery cell assembly 100, and thereby enhancing the thermal control of the battery cell 10. In an embodiment, the thermal conductive layer 60 is formed by thermal conductive materials, including thermal conductive adhesive, thermal conductive silicone, etc., and the thermal conductive layer 60 is formed by coating the thermal conductive materials on an inner surface of the side plate 20.

In an embodiment, the cooling medium is a coolant. In another embodiment, the cooling medium is air.

As shown in FIG. 1, the cooling component 50 further includes a cooling inlet 52 and a cooling outlet 53 in fluid communication with the cooling channels 51. The cooling inlet 52 is located on the first end plate 30, and the cooling outlet 53 is located on the second end plate 31.

The first end plate 30 is also provided with multiple first cooling medium delivery pipelines (not shown) connecting the cooling inlet 52 and the cooling channels 51, and the second end plate 31 is also provided with multiple second cooling medium delivery pipelines 54 connecting the cooling channels 51 and the cooling outlet 53. The first cooling medium delivery pipelines and the second cooling medium delivery pipelines 54 are matched with the cooling channels 51, respectively. The cooling medium enters the cooling channel 51 after passing through the cooling inlet 52 and the first cooling medium delivery pipelines and then flows through the second cooling medium delivery pipelines 54 and converges before flowing out through the cooling outlet 53.

Several possible embodiments of the local structure of the battery cell assembly 100 are described below. It should be noted that this is only an example, and other embodiments can use various alternative ways.

FIG. 2 shows an embodiment of the local structure of the battery cell assembly 100. As shown in the figure, multiple connecting structures 40 are integrated into both side plates 20 of the battery cell assembly 100, that is, multiple connecting structures 40 are provided on both the first side plate 21 and the second side plate 22.

Both the cooling channels 51 and the connecting structure 40 are integrated into the first side plate 21. The cooling channels 51 are closer to the battery cell 10 relative to the connecting structure 40. Wherein, the cooling channels 51 are provided on the side of the first side plate 21 near the battery cell 10, and the connecting structure 40 is provided on the side of the second side plate 22 away from the battery cell 10.

The connecting structure 40 is located on an outer side of the side plate 20, which is conducive to the installation of adjacent battery cell assemblies 100 through the connecting structures 40, improving the convenience of the installation of battery cell assemblies 100, facilitating the assembly of multiple battery cell assemblies 100, and also improving space utilization, allowing more battery cell assemblies 100 to be placed in the same volume, expanding the capacity of battery pack 1, and improving energy density.

The connecting structure 40 and a thermal insulation layer 70 are integrated into the second side plate 22. The thermal insulation layer 70 is provided on the side of the second side plate 22 near the battery cell 10, and the connecting structure 40 is provided on the side of the side plate 20 away from the battery cell 10. The connecting structure 40 is provided on the outer side of the second side plate 22, and the thermal insulation layer 70 is provided on the side of the second side plate 22 near the battery cell 10. This can reduce the heat exchange between adjacent battery cell assemblies 100, and the combination of the thermal insulation layer 70 and the cooling component 50 can achieve better temperature retention effect.

In one embodiment, a thermal insulation coating is coated on an inner surface of the second side plate 22, and the thermal insulation coating is silica aerogel. The inner surface of the second side plate 22 refers to the surface of the second side plate near the battery cell. In another embodiment, a thermal insulation channel is integrated into the second side plate 22, and the thermal insulation channel is filled with thermal insulation material to form the thermal insulation layer 70.

The multiple cooling channels 51 are arranged sequentially along a width direction of the first side plate 21, and the cooling channels 51 extend along the length direction of the first side plate 21 and run through the first side plate 20, that is, the cooling channels 51 extend along a front edge of the first side plate 20 to a rear edge of the side plate 20. When the cooling medium flows through the cooling channels 51, the cooling medium can flow along the length direction of the first side plate 21 from the front edge of the first side plate 21 to the rear edge of the first side plate 21.

The spacing between adjacent cooling channels 51 is the same, and the cooling channels 51 are evenly distributed along the width direction of the side plate 20. This can not only lower the temperature of the battery cell, but also make the temperature of the battery cell more uniform.

The connecting structure 40 includes multiple convex locking pieces 41 and concave locking pieces 42 that are alternately arranged and matched with each other. The concave locking piece 42 has a corresponding cavity 43 for receiving the corresponding convex locking piece 41. When adjacent battery cell assemblies are connected, the convex locking pieces 41 slide into the cavities 43 of the corresponding concave locking pieces 42 and engage with the corresponding concave locking pieces 42 in a locking manner.

The convex locking pieces 41 and the concave locking pieces 42 are in an interference fit at the middle and/or rear end of the concave locking pieces 42 along a direction in which the convex locking pieces 41 slide inside the concave locking pieces 42. This makes the convex locking pieces 41 and the concave locking pieces 42 stably connected together, reducing the possibility of the convex locking pieces 41 shaking in the concave locking pieces 42.

In one embodiment, the connecting structure 40 may include a mortise and tenon structure.

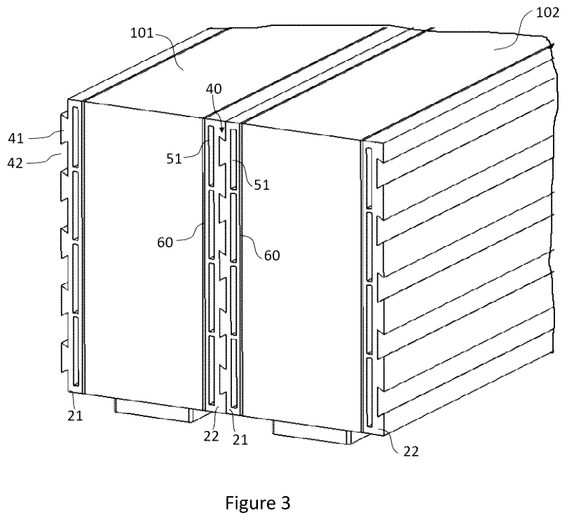

As shown in FIG. 3, multiple battery cell assemblies 100 as that shown in FIG. 2 are assembled together. The battery cell assemblies 100 includes a first battery cell assembly 101 and a second battery cell assembly 102, and the first battery cell assembly 101 and the second battery cell assembly 102 are connected to each other through the connecting structures 40.

The first battery cell assembly 101 and the second battery cell assembly 102 can be connected together through the collaboration of the convex locking pieces 41 and the concave locking pieces 42. Wherein, the convex locking pieces 41 of the first battery cell assembly 101 slide into the concave locking pieces 42 of the second battery cell assembly 102, and lock inside the concave locking pieces 42, thereby achieving interlocking engagement between the first battery cell assembly 101 and the second battery cell assembly 102. This allows both sides of the battery cell assembly 100 to be interlocked with adjacent battery cell assemblies through the connecting structures 40, allowing for assembly and disassembly without the need for tools, facilitating the arbitrary combination and installation of multiple battery cell assemblies 100 as needed, and improving the convenience of assembling the battery cell assemblies 100.

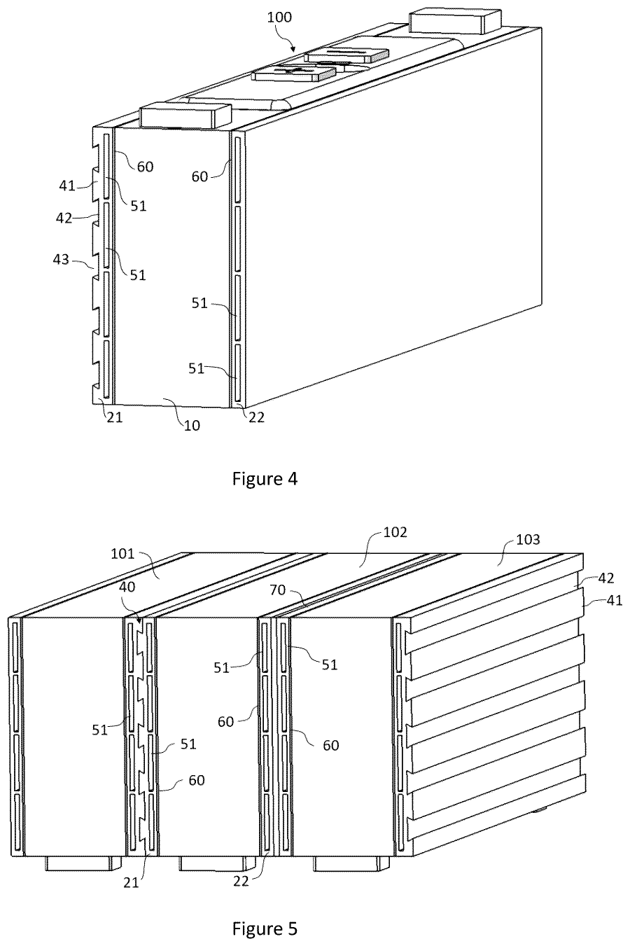

FIG. 4 shows another embodiment of the local structure of the battery cell assembly 100. As shown in the figure, multiple cooling channels 51 are integrated into both side plates 20 of the battery cell assembly 100, which can cool the battery cell 10 from the two sides, further increasing the cooling area and improving the cooling effect on the battery cell 10.

The side plates 20 includes a first side plate 21 and a second side plate 22 located on both sides of the battery cell 10. Wherein, cooling channels 51 and a first connecting structure are integrated into the first side plate 21, and the first connecting structure can include convex locking pieces 41 and concave locking pieces 42. Adjacent battery cell assemblies 100 can be connected to each other through the first connecting structures, which have been elaborated in detail in above embodiments and will not be repeated here.

The cooling channels 51 are provided on the second side plate 22. When the adjacent battery cell assemblies 100 are connected, they are connected to each other through a second connecting structure. The second connecting structure may include silica aerogel. The connection with adjacent battery cell assemblies is realized by coating aerogel on the outer surface of the second side plate 22. This not only enables the connection of adjacent battery cell assemblies 100, but also allows the aerogel to form the thermal insulation layer 70. The thermal insulation layer 70 is located between adjacent battery cell assemblies 100, which can reduce the heat exchange of adjacent battery cell assemblies 100.

FIG. 5 illustrates the assembly of multiple battery cell assemblies 100 as that shown in FIG. 4. Specifically, the battery cell assemblies 100 may include a first battery cell assembly 101, a second battery cell assembly 103, and a third battery cell assembly 103. The second battery cell assembly 102 is connected to the first battery cell assembly 101 and the third battery cell assembly 103 through the connecting structures, respectively.

In one embodiment, on one side of the side plate 21, the second battery cell assembly 102 is connected to the first battery cell assembly 101 through the first connecting structure, and the convex locking pieces 41 of the first battery cell assembly 101 slide into the matching concave locking pieces 42 of the second battery cell assembly 102 to achieve interlocking. The specific connection method has been explained in the above embodiments and will not be repeated here.

In another embodiment, on one side of the side plate 22, the second battery cell assembly 102 is connected to the third battery cell assembly 103 through the second connecting structures. The second connecting structure includes silica aerogel. Specifically, the connection is realized by coating the outer surface of the second side plate 22 with aerogel. Here, the silica aerogel can not only connect adjacent battery cell assemblies 100, but also a thermal insulation layer 70 can be formed between the adjacent battery cell assemblies 100, reducing the heat exchange between the adjacent battery cell assemblies 100.

In this embodiment, the first connecting structure and the second connecting structure are alternately arranged between the battery cells, which not only allows for the flexible combination and connection of the battery cell assemblies 100, but also allows for the formation of the thermal conductive layer 60 and the thermal insulation layer 70 on the sides of the battery cell 10. The thermal conductive layer 60 can facilitate the heat exchange between the battery cell 10 and the cooling medium, and the thermal insulation layer 70 can reduce the heat exchange between the battery cells 10. The combination of the thermal conductive layer 60 and the thermal insulation layer 70 can achieve better temperature retention effect, better thermal management of the battery cell 10, and augment the performance of the battery cell 10.

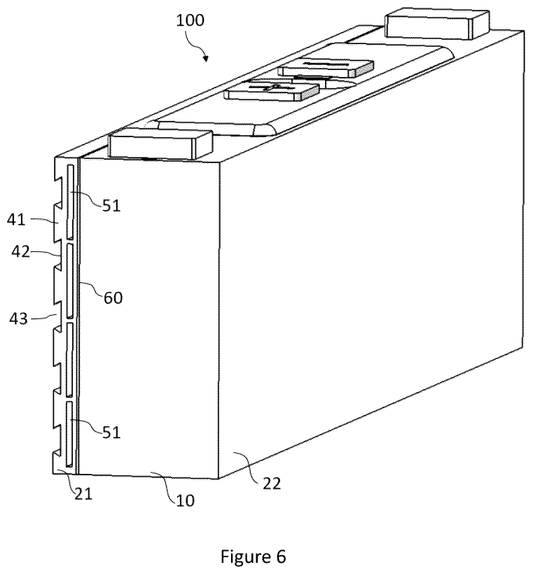

FIG. 6 illustrates another embodiment of the local structure of the battery cell assembly 100. As shown in the figure, the first side plate 21 of the battery cell assembly 100 is integrated with cooling channels 51 and a connecting structure 40. A thermal conductive layer 60 is provided between the cooling channels 51 and the battery cell 10 to facilitate the heat exchange between the cooling channels 51 and the battery cell 10.

When adjacent battery cell assemblies 100 are connected, one side thereof can be connected to each other through the connecting structure 40. The first side plate 21 is integrated with the cooling channels 51 and a first connecting structure. The first connecting structure may include convex locking pieces 41 and concave locking pieces 42. The adjacent battery cell assemblies 100 can be connected to each other through the first connecting structure, which have been elaborated in detail in the above embodiments and will not be repeated here.

When the adjacent battery cell assemblies 100 are connected, the other side thereof can be connected with each other through a second connecting structure. The second connecting structure includes silica aerogel. Specifically, when the adjacent battery cell assemblies are connected, the outer surface of the second side plate 22 can be coated with the silica aerogel to realize the connection. Here, the silica aerogel can not only connect adjacent battery cell assemblies 100, but also form the thermal insulation layer 70 between the adjacent battery cell assemblies 100, reducing the heat exchange between battery cell assemblies.

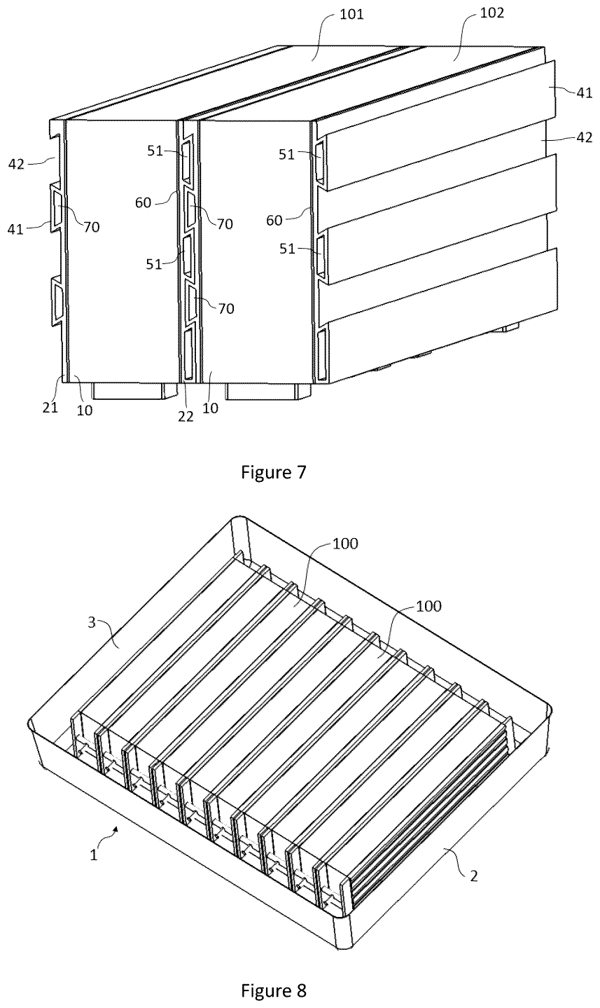

FIG. 7 illustrates yet another embodiment of the local structure of a battery cell assembly 100. The two side plates 20 of the battery cell assembly 100 are provided with the connecting structures 40. The connecting structures 40 can include convex locking pieces 41 and concave locking pieces 42. The adjacent battery cell assemblies 100 are connected to each other through the connecting structures 40. How the connecting structures 40 connect the adjacent battery cell assemblies 100 has been explained in the above embodiments and will not be repeated here.

The battery cell assemblies 100 include a first battery cell assembly 101 and a second battery cell assembly 102.

On one of the side plates, namely the first side plate 21, the cooling channels 51 are integrated with the connecting structures 40. Specifically, the connecting structure 40 includes multiple convex locking pieces 41 and concave locking pieces 42 that are alternately arranged and matched with each other. The convex locking piece 41 has a through hollow structure, and the cooling channel 51 is formed by the hollow structure. The thermal conductive layer 60 is provided between the cooling channels 51 and the battery cell 10 to increase the heat exchange between the battery cell 10 and the cooling medium. The thermal conductive layer 60 is formed by thermal conductive materials, including thermal conductive adhesive, thermal conductive silicone, etc. The thermal conductive layer 60 can be formed by coating the thermal conductive materials on the inner surface of the first side plate 21.

On the other side plate 20, namely the second side plate 22, the thermal insulation layer 70 is integrated with the connecting structure 40. The connecting structure 40 includes multiple convex locking pieces 41 and concave locking pieces 42 that are alternately arranged and matched with each other. The convex locking piece 41 has a through hollow structure. The hollow structure is filled with silica aerogel to form the thermal insulation layer 70. The thermal insulation layer 70 can reduce the heat exchange between the battery cells 10.

In this embodiment, both the first side plate 21 and the second side plate 22 are provided with connecting structures. When the first battery cell assembly 101 and the second battery cell assembly 102 are connected, the convex locking pieces 41 of the first battery cell assembly 101 slides into the concave locking pieces 42 of the second battery cell assembly 102 to achieve interlocking engagement. This allows the adjacent battery cell assemblies 100 to interlock and engage with each other through the connecting structures without the need for tools, allowing for the free selection of different numbers of the battery cell assemblies 100 according to the requirements of energy load. Furthermore, due to the integration of the cooling channels 51 and the thermal insulation layer 70 with the connecting structure, the cooling channels 51 and the thermal insulation layer 70 do not require extra space, which further reduces the volume of the entire battery cell assemblies 100 and increases space utilization. More battery cell assemblies 100 can be placed in the same volume, further expanding the capacity of battery pack 1 and further improving energy density.

FIG. 8 shows a partial perspective view of the battery pack 1. The battery pack 1 includes a shell 2 formed with an accommodating chamber 3 in the interior. The battery cell assemblies 100 in the above multiple embodiments are connected to each other and placed in the accommodating chamber 3. In the battery pack 1, any number of battery cell assemblies 100 can be chosen as needed, and multiple battery cell assemblies 100 can be arranged side by side.

The above battery pack 1 can be installed on the vehicle to provide power for the vehicle, and the battery pack 1 of the vehicle can be provided with a matching number of battery cell assemblies 100 as needed.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure and are given only for the purpose of enabling those skilled in the art to clearly understand the principles of the invention. It should be understood by those skilled in the art that the above discussion to any embodiment is only illustrative, and is not intended to imply that the disclosed scope of the embodiments of the present disclosure (including claims) is limited to these examples; and under the overall concept of the invention, the technical features in the above embodiments or different embodiments can be combined with each other to produce many other changes in different aspects of embodiments of the invention that is not provided in detailed description for the sake of brevity. Therefore, any omission, modification, equivalent replacement, improvement, etc. made within the spirit and principle of the embodiment of the invention shall be included in the scope of protection claimed by the invention.

1. A battery cell assembly, comprising:
a battery cell;
a pair of side plates located on opposite sides of the battery cell, at least one of the side plates is provided with a connecting structure configured to connect an adjacent battery cell assembly; and
a cooling component for cooling the battery cell, wherein the cooling component is at least partially integrated into the at least one of the side plates.

2. The battery cell assembly as claimed in claim 1, wherein the cooling component comprises multiple cooling channels extending along a length direction of the at least one of the side plates and running through the at least one of the side plates, and further wherein the multiple cooling channels are integrated into the side plate.

3. The battery cell assembly as claimed in claim 1, wherein the cooling component is closer to the battery cell than the connecting structure, and the connecting structure is located on a side of the at least one of the side plates away from the battery cell.

4. The battery cell assembly as claimed in claim 1, wherein the cooling component comprises cooling channels extending along a length direction of the at least one of the side plates and running through the at least one of the side plates, the connecting structure is located on an outer side of the at least one of the side plates, and the cooling channels are integrated with the connecting structure.

5. The battery cell assembly as claimed in claim 4, wherein the connecting structure comprises multiple convex locking pieces and concave locking pieces that are alternately arranged, the convex locking piece has a through hollow structure, and the cooling channel is formed by the hollow structure.

6. The battery cell assembly as claimed in claim 1, wherein the connecting structure comprises multiple convex locking pieces and concave locking pieces that are alternately arranged, and the connecting structure is configured so that when the adjacent battery cell assembly is connected, the convex locking pieces slide into the concave locking pieces to interlock the adjacent battery cell assembly.

7. The battery cell assembly as claimed in claim 6, wherein the convex locking pieces and the concave locking pieces establish an interference fit at a middle and/or a rear end of the concave locking pieces along a direction in which the convex locking pieces slide inside the concave locking pieces.

8. The battery cell assembly as claimed in claim 1, wherein the connecting structure comprises a mortise and tenon connecting structure through which the adjacent battery cell assembly is detachably connected to the battery cell assembly.

9. The battery cell assembly as recited in claim 1, wherein at least one of the side plates is provided with a second connecting structure configured to connect a second adjacent battery cell assembly.

10. The battery cell assembly as recited in claim 9, wherein the second connecting structure includes an aerogel coated on the at least one of the side plates to connect the battery cell assembly and the second adjacent battery cell assembly.

11. The battery cell assembly as recited in claim 10, comprising a thermal insulation layer provided between the battery cell and the second connecting structure.

12. The battery cell assembly as recited in claim 11, wherein the thermal insulation layer is a thermal insulation coating or a thermal insulation channel.

13. The battery cell assembly as recited in claim 1, comprising a first end plate connected to the pair of side plates and including a cooling inlet in fluid communication with the cooling component.

14. The battery cell assembly as recited in claim 13, comprising a second end plate connected to the pair of side plates and including a cooling outlet in fluid communication with the cooling component.

15. A battery pack, comprising:
a shell arranged to provide an accommodating chamber;
a first battery cell assembly and a second battery cell assembly received within the accommodating chamber; and
a mortise and tenon connecting structure configured to detachably connect the first battery cell assembly to the second battery cell assembly.

16. The battery pack as claimed in claim 15, wherein the mortise and tenon connecting structure includes multiple convex locking pieces and concave locking pieces that are alternately arranged and matched with each other, and the convex locking pieces are configured to slide into the concave locking pieces to detachably connect the first battery cell assembly to the second battery cell assembly.

17. The battery pack as claimed in claim 15, comprising a second connecting structure configured to connect the first battery cell assembly or the second battery cell assembly to a third battery cell assembly.

18. The battery pack as recited in claim 17, wherein the second connecting structure includes an aerogel coated on a portion of the first battery cell assembly or the second battery cell assembly to connect the first battery cell assembly or the second battery cell assembly to the third battery cell assembly.

19. The battery pack as recited in claim 15, comprising a cooling component integrated with the mortise and tenon connecting structure.

20. The battery pack as recited in claim 19, wherein the cooling component includes a cooling channel.
